(19) United States
(12) Patent Application Publication
(10) Pub. No.: US 2014/0178851 A1
(43) Pub. Date: Jun. 26, 2014

(54) PROCESS FOR CREATING EDUCATIONAL ASSESSMENTS USING REUSABLE MODULAR COMPONENTS

(71) Applicants: STEVEN TANG, SAN ANTONIO, TX (US); VAMSIDHAR MUKKAMALA, SAN ANOTONIO, TX (US)

(72) Inventors: STEVEN TANG, SAN ANTONIO, TX (US); VAMSIDHAR MUKKAMALA, SAN ANOTONIO, TX (US)

(21) Appl. No.: 14/135,545

(22) Filed: Dec. 19, 2013

Related U.S. Application Data
(60) Provisional application No. 61/745,686, filed on Dec. 24, 2012.

(51) Int. Cl. G09B 7/02

(52) U.S. Cl. CPC G09B 7/02
USPC 434/362

(57) ABSTRACT

Some embodiments include a process for creating educational assessments using modular or reusable widget components that enables a non-technical user to assemble a test experience and to define test scoring logic using simple WYSISYG approaches to UI design in some embodiments. In some embodiments, the process comprises an intuitive widget-driven WYSIWYG workflow process that allows the user to assemble a test experience and define test scoring logic using WYSIWYG approaches to UI design. In some embodiments, the modular and reusable widgets used in the intuitive workflow process to create educational assessments replace pre-determined templates that constrain the creative ability of the user.

### CLAIM OF BENEFIT TO PRIOR APPLICATION

This application claims benefit to U.S. Provisional Patent Application 61/745,686, entitled “A WYSIWYG Process For Creating Questions in an Educational Assessment Using Reusable Modular Components,” filed Dec. 24, 2012. The U.S. Provisional Patent Application 61/745,686 is incorporated herein by reference.

### BACKGROUND

Embodiments of the invention described in this specification relate generally to user interface (UI) design, and more particularly, to WYSIWYG (i.e., “what you see is what you get”) processes and approaches to UI design.

With the inception of the common core standards, the next generation of student assessments will require conventional item types such as multiple choice and constructed response; as well as advanced item types, technology enabled/enhanced items (TEIs), involving a combination of student interactions. TEIs require features including, but not limited to: drag, drop, tiles, identify, and arrange. These items will need to be authored online by educators and test publishers, and administered online to students. Educators need a means to create these test questions quickly and efficiently.

The existing systems and processes used in the field are expensive in terms of time and cost and have limited capabilities that constrain content creation. For instance, current item bank software tends to provide a set of pre-determined question types which educators must utilize to create their items, i.e., multiple choice, open-ended, etc. These templates do not allow for the flexibility required to create a variety of test questions involving complex interactions in an intuitive way, without requiring the user or assessment programming knowledge.

Also, current processes for test question development are mostly template driven and only allow for producing test questions within the scope of the template. Most of these conventional templates are developed for historically traditional question types such as selected response (multiple choice), short response, fill-in etc. For advanced question types involving user interactions, the template approach may be prohibitively expensive, time consuming and may limit the creativity of test authors.

Therefore, what is needed is a way to unleash the creativity of test authors who create educational assessments and allow for the development of innovative test questions by using simple modular and reusable components (hereafter referred to as “widgets”) and an intuitive workflow process that enables a non-technical user to assemble a test experience and to define test scoring logic using simple WYSISYG approaches to UI design.

### BRIEF DESCRIPTION

Some embodiments of the invention include a novel process for creating educational assessments using modular or reusable widget components that enables a non-technical user to assemble a test experience and to define test scoring logic using simple WYSISYG approaches to UI design in some embodiments. In some embodiments, the process comprises an intuitive widget-driven WYSIWYG workflow process that allows the user to assemble a test experience and define test scoring logic using WYSIWYG approaches to UI design. In some embodiments, the modular and reusable widgets used in the intuitive workflow process to create educational assessments replace pre-determined templates that constrain the creative ability of the user.

The preceding Summary is intended to serve as a brief introduction to some embodiments of the invention. It is not meant to be an introduction or overview of all inventive subject matter disclosed in this specification. The Detailed Description that follows and the Drawings that are referred to in the Detailed Description will further describe the embodiments described in the Summary as well as other embodiments. Accordingly, to understand all the embodiments described by this document, a full review of the Summary, Detailed Description, and Drawings is needed. Moreover, the claimed subject matters are not to be limited by the illustrative details in the Summary, Detailed Description, and Drawings, but rather are to be defined by the appended claims, because the claimed subject matter can be embodied in other specific forms without departing from the spirit of the subject matter.

### BRIEF DESCRIPTION OF THE DRAWINGS

Having described the invention in general terms, reference is now made to the accompanying drawings, which are not necessarily drawn to scale, and wherein:

FIG. 1 conceptually illustrates a process for creating educational assessments in a WYSIWYG manner using modular components in some embodiments.

FIG. 2 is a continuation of the process illustrated in FIG. 1.

FIG. 3 is a continuation of the process illustrated in FIGS. 1 and 2.

FIG. 4 conceptually illustrates an example graphical user interface (GUI) of a software application that creates educational assessments by using a set of reusable modular GUI components in some embodiments.

FIG. 5 conceptually illustrates another example GUI of a software application that creates educational assessments by using a set of reusable modular GUI components in some embodiments.

FIG. 6 conceptually illustrates an electronic system with which some embodiments of the invention are implemented.

### DETAILED DESCRIPTION

In the following detailed description of the invention, numerous details, examples, and embodiments of the invention are described. However, it will be clear and apparent to one skilled in the art that the invention is not limited to the embodiments set forth and that the invention can be adapted for any of several applications.

Some embodiments of the invention include a novel process for creating educational assessments using modular or reusable widget components that enables a non-technical user to assemble a test experience and to define test scoring logic using simple WYSISYG approaches to UI design in some embodiments. In some embodiments, the process comprises an intuitive widget-driven WYSIWYG workflow process that allows the user to assemble a test experience and define test scoring logic using WYSIWYG approaches to UI design. In some embodiments, the modular and reusable widgets used in the intuitive workflow process to create educational assessments replace pre-defined templates that constrain the creative ability of the user.

As stated above, with the inception of the common core standards, the next generation of student assessments will require conventional item types such as multiple choice and constructed response; as well as advanced item types, technology enabled/enhanced items (TEIs), involving a combination of student interactions. TEIs require features including, but not limited to: drag, drop, tiles, identify, and arrange. These items will need to be authored online by educators and test publishers, and administered online to students. Educators need ways to create these test questions quickly and efficiently. Embodiments of the invention described in this specification solve such problems by providing an intuitive workflow process in which non-technical users create test questions involving complex interactions using simple re-usable components referred to as “widgets” in conjunction with the intuitive WYSIWYG workflow.

Most systems and processes that exist today rely on a template driven approach due to the complexity involved in defining a scoring logic for an advanced test question that relies on test takers interaction. The templates are pre-programmed due to the dependency on various elements that comprise the test question. When changes that extend beyond the scope of the template are required, current systems and processes treat that as a custom implementation and require additional time and resources to develop such questions. With the existing processes, test authors have greater dependency on software programmers to develop a test question.

The embodiments described in this specification differ from and improve upon such currently existing systems and processes by replacing pre-defined templates with simple modular and reusable widgets and an intuitive process/workflow for a non-technical user to assemble a test experience and to define test scoring logic using simple WYSISYG approaches to user interface design. This enables any user to create complex test questions without needing to pass detailed specifications to software programmers who in turn would develop each item individually. Test authors can define a scoring rule based on the state of various widgets and incorporate advanced scoring logic using a WYSIWYG interface. In addition, these embodiments improve upon the currently existing options by overcoming the limitations and creative constraints of the current template driven processes because it allows for any user (e.g., technically- or not technically-oriented) to create complex test questions without needing to pass detailed specifications to software programmers who in turn would develop each item individually. Test authors can define a scoring rule based on the state of various widgets and incorporate advanced scoring logic using a WYSIWYG interface.

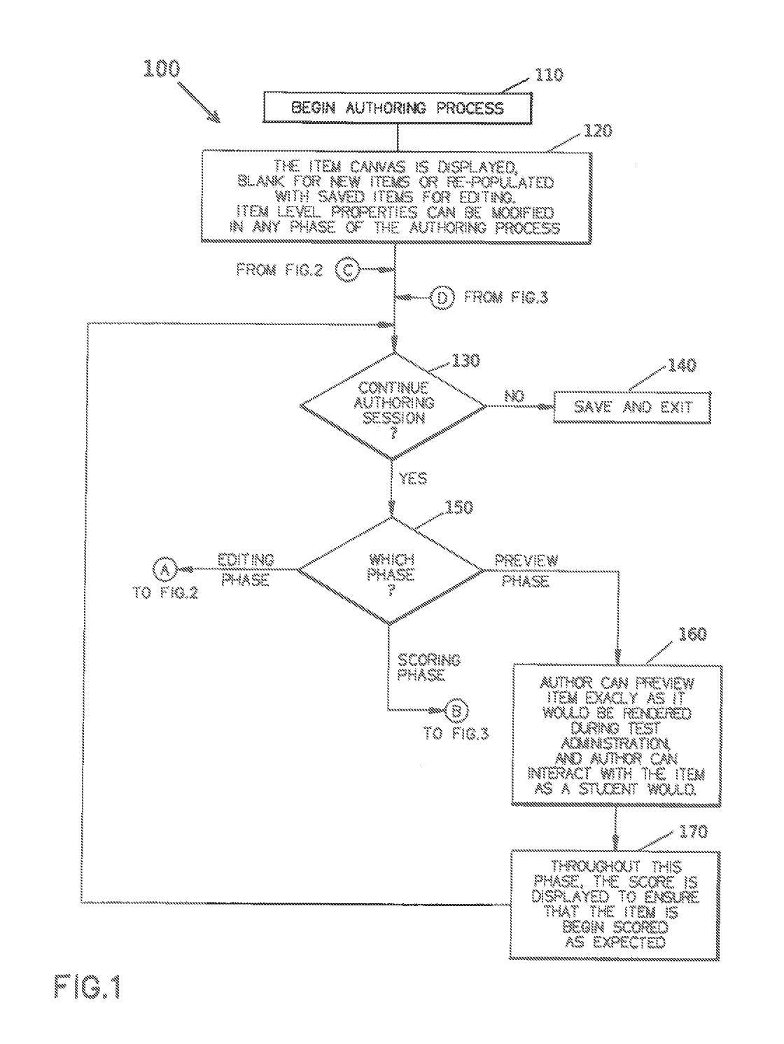

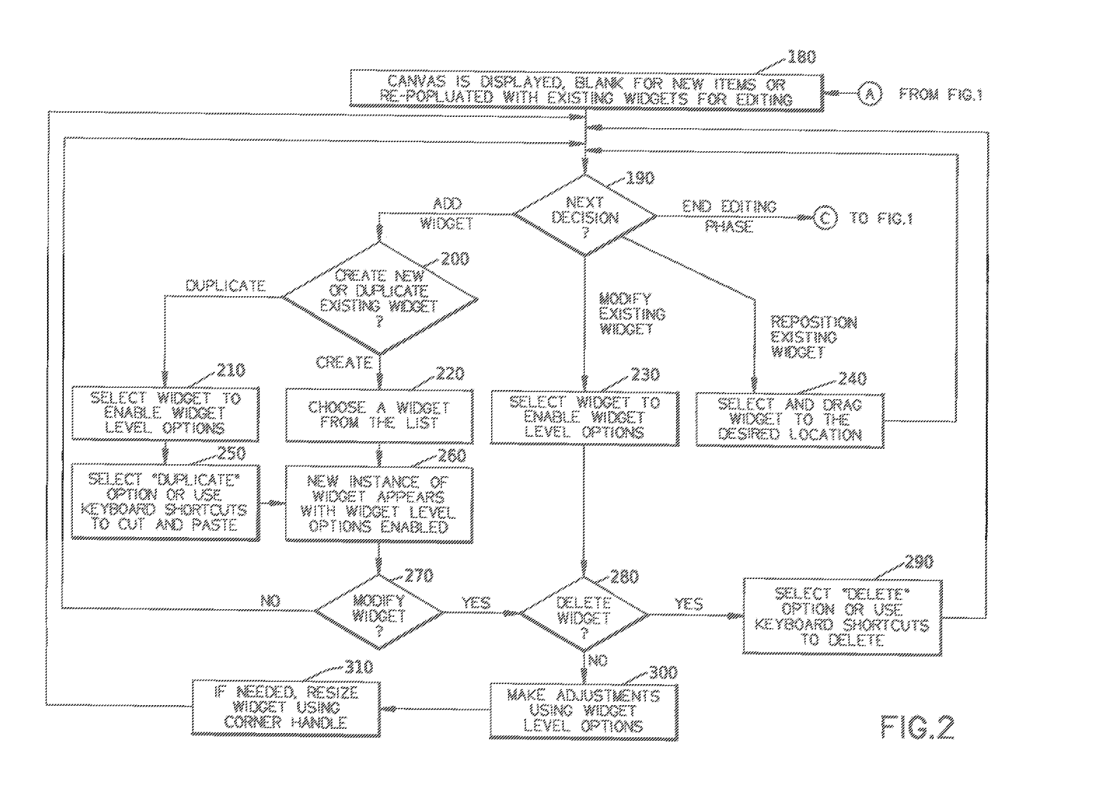

By way of example, FIGS. 1-3 conceptually illustrate a process for creating educational assessments in a WYSIWYG manner using modular components in some embodiments. In some embodiments, the process is performed by a software program running on a computing device. In some embodiments, the software program is a content authoring application. As shown in FIG. 1, the process 100 starts (at 110) when the authoring application begins. The process then displays (at 120) an item canvas. In some embodiments, the authoring application comprises a set of reusable graphical tools, components, modules, and other such widgets used to create an assessment in a canvas display area. In some embodiments, a user of the authoring application selects a navigation menu option to open a new editing canvas or load a saved editing canvas. In some embodiments, a set of item level properties associated with the canvas are loaded upon opening the canvas. A set of default properties are loaded when a new editing canvas is opened, while a set of previously stored properties are loaded when a saved canvas is loaded.

While a user is interacting with the authoring application, the process 100 determines (at 130) whether the authoring session is to continue or end. In some embodiments, when the user continues interacting with the editing canvas or other items in the GUI, the process continues the authoring session by transitioning to 150 to determine which phase of the authoring session is active (i.e., editing phase, scoring phase, or the preview phase, which are described in greater detail below). On the other hand, if the process 100 determines that the authoring session is finished, the process saves (at 140) the work and item level properties and then exits the application. In some embodiments, the item level properties can be modified (and saved) at any time during the authoring process, but the authoring application will automatically save the properties upon exit.

When the authoring process continues (instead of exiting), the process determines (at 150) which phase is active. In some embodiments, the authoring application comprises an editing phase, a scoring phase, and a preview phase. The editing and scoring phases are described in greater detail below. When the process determines that the preview phase is active, the process (at 160) displays the current items in the editing canvas in a WYSIWYG preview mode where the user can preview items in the same approximate rendering as would be printed or produced during administration of a test. In some embodiments, the process allows the user to interact with the items in the WYSIWYG preview mode just as a test-taking student would interact with the test. Additionally, in some embodiments the process 100 displays (at 170) the score contemporaneously with the user testing the items in the WYSIWYG preview mode. This allows the author to ensure that scoring is being accurately calculated and tabulated for each of the canvas items. Next, the process transitions back to 130 to determine if the session is continuing, as described above.

When the process 100 determines (at 150) that the editing phase is active, the author who is using the authoring application is permitted to make widget selections, widget deletions, modifications to the size and appearance of the widgets, repositioning the widgets, and make widget level option changes. Thus, as illustrated in FIG. 2, in some embodiments, the process 100 (at 180) displays the editing canvas when the process determines (at 150) that the editing phase is active. In some embodiments, the process displays a blank canvas for a new assessment, while displaying a set of previously saved widgets associated with a previously edited canvas. Next, the process determines (at 190) what the next decision is during the editing phase. When the next decision is to end the editing phase, the process transitions back to 130 to determine if the session is continuing, as described above. The authoring application also permits the user to make one or more non-ending editing decisions, including at least adding a widget to the canvas, modifying a widget already in the canvas, and repositioning an existing widget in the canvas.

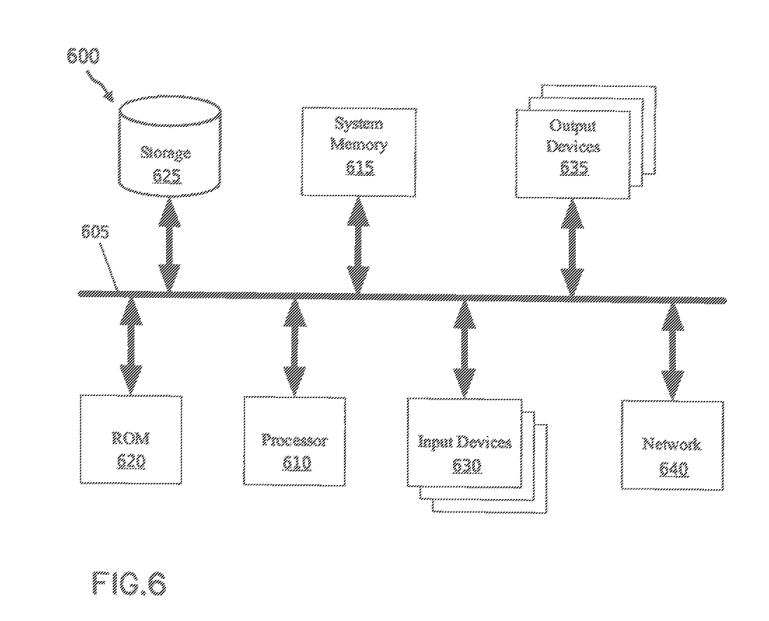

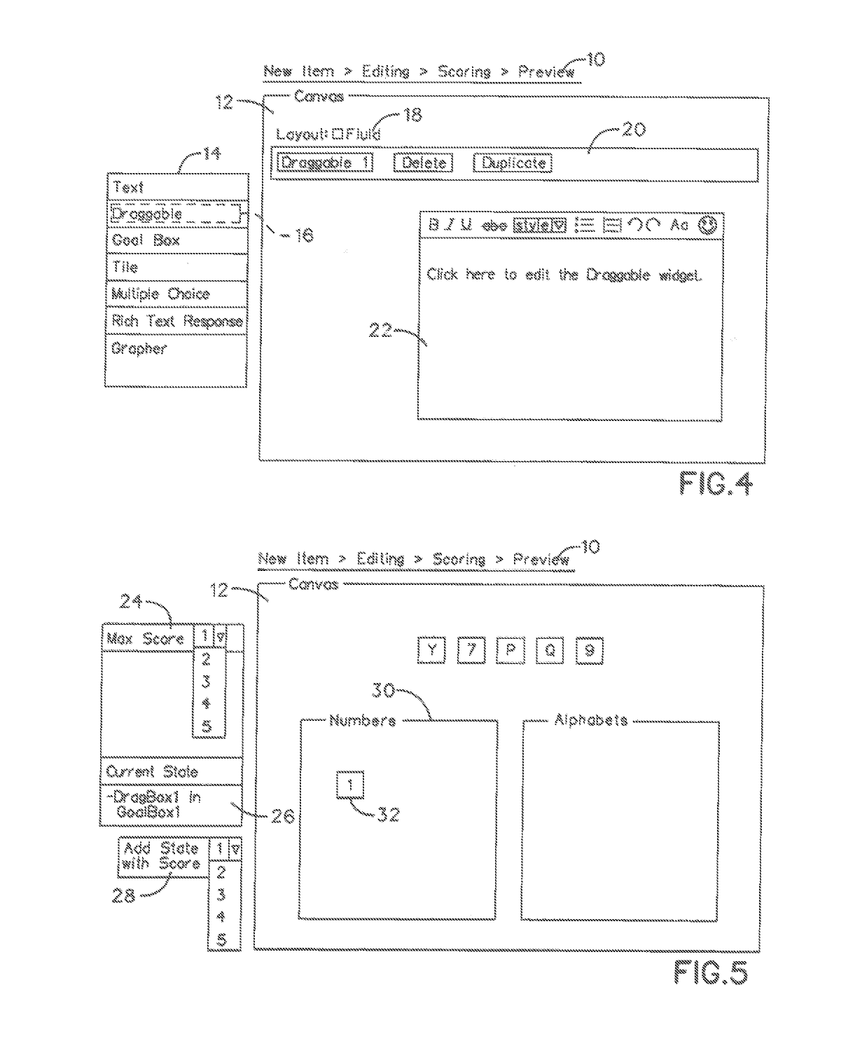

In some embodiments, when a widget is added, the process 100 determines (at 200) whether the new widget to add is a duplicate of an existing canvas widget or a newly created widget. When the process receives a selection (at 220) of a widget from a list (such as widget list 14, which is described further below by reference to FIG. 4), the process creates a new instance (at 260) of the selected widget for display in the editing canvas with the item level options of the widget available for editing (e.g., the draggable widget 22 which is displayed in the canvas with the widget level options 20 displayed adjacent to the canvas, as described below by reference to FIG. 4). Next, the process 100 determines (at 270) whether the new widget is being modified. When the widget is not being modified, the process transitions back to 190 to determine the next decision, as described above. On the other hand, when the widget is being modified, the process determines (at 280) whether the widget modification is a deletion operation to remove the widget from the presently active editing canvas. When a selection of GUI delete tool or a keyboard delete option is detected (at 290), the process removes the widget from the active canvas, along with the widget level options. The process then transitions back to 190 for the next decision, as described above.

On the other hand, when the process 100 receives a set of widget level option modifications, the process determines (at 280) that the widget modification is not a deletion operation. The process then modifies (at 300) the widget by making the adjustments according to the widget level options. In some embodiments, the widget display size can be resized outside of the widget level options. For instance, the author user of the application can use a widget handle to grab and resize the widget in the editing canvas. The process 100 resizes (at 310) the widget according to the amount of canvas resizing performed by the author using the corner handle of the widget. The process then transitions back to 190 for the next decision, as described above.

In some embodiments, when the process receives a selection of widget without movement of the widget in the canvas, the process determines that the widget is selected for modification and enables (at 230) widget level options for modification. In some embodiments, the process determines (at 280) whether the widget modification is a deletion and performs the modifications to widget accordingly, as described above.

In some embodiments, when the process receives a selection of widget with a contemporaneous movement of the widget in the canvas, the process determines that the widget is selected for repositioning and identifies (at 240) the desired location to which the widget is moved. The process 100 then transitions back to 190 to determine the next decision, as described above.

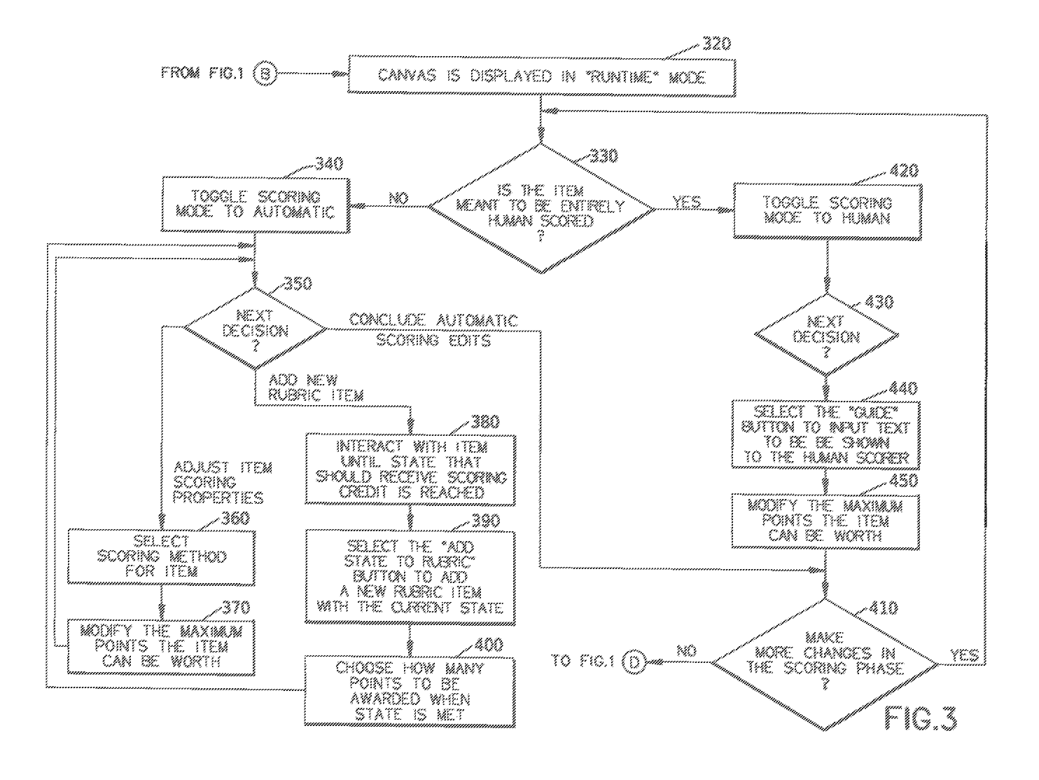

Referring back to FIG. 1, when the process 100 determines (at 150) that the scoring phase is active, the author who is using the authoring application is able to simulate the assessment being created in the canvas in a preview mode. Thus, as illustrated in FIG. 3, in some embodiments, the process 100 (at 320) displays the editing canvas in “runtime mode”, which is an active mode that simulates an actual testing mode and even keeps a running tabulation for scoring the test in progress. In the runtime mode, the process 100 first determines (at 330) whether the test item is intended to be scored by a human operator (i.e., not by the application at runtime). When the process determines that the scoring is not human scored, the process toggles (at 340) to an automatic scoring mode that keeps score contemporaneously with the author taking the assessment. When the process 100 determines, on the other hand, that the assessment is to be scored by a human operator, the process toggles (at 420) to human scoring mode, which is described further below.

When in automatic scoring mode, the process determines (at 350) the next decision. In some embodiments, one of at least three possible decisions is made, including concluding automatic scoring edits, adding one or more new scoring rubric items, and adjusting one or more item scoring properties. When the process determines to conclude automatic scoring edits, the process determines (at 410) whether to make more changes in the scoring phase. When more changes are to be made, the process transitions back to 330 to determine whether the change is meant to be entirely human scored or not, as described above. When the process determines, on the other hand, that no more scoring changes are to be made, the process transitions back to 130 to determine whether to continue the authoring session, as described above by reference to FIG. 1.

When the process 100 determines that the next decision is to add new scoring rubric items, the process interacts (at 380) with item until a state that should receive scoring credit is reached. In some embodiments, the process then adds (at 390) a new scoring rubric item with the current state to the overall scoring rubric. In some embodiments, the process receives a selection of an option to add the state to the scoring rubric prior to adding the new scoring rubric item. Next, the process sets (at 400) the number of points to award when the defined state is satisfied. In some embodiments, the process receives input specifying the number of points to award prior to setting the number of points to award. Then the process transitions back to 350 to determine the next decision.

When the process 100 determines that the next decision is to adjust item scoring properties, the process selects (at 360) the scoring method for the item. Then the process modifies (at 370) the maximum points that the item can be worth. The process then transitions back to 350 to determine the next decision.

When in human scoring mode, the process determines (at 430) the next decision. The process the selects (at 440) an option to display a guide for the human operator scoring the test. Then the process modifies (at 450) the maximum points that the item can be worth. Next, the process determines (at 410) whether more changes are to be made in the scoring phase, as described above.

The process 100 of the present disclosure generally works according to the steps in the three phases, and in the order listed. However, in some embodiments, the order of the steps may differ from those shown in FIGS. 1-3, as the ordering shown in these figures is only exemplary and not intended to limit the scope or nature of the relationships between the various process steps. Regardless of the ordering of the steps, the process allows an author to create a test question interactively using a free flow layout in a cost effective and intuitive manner. Also, the Scoring phase allows for specifying logical operators (And/Or) between various combinations of the widget states. The logical operators can be evaluated based on the ‘state’ match criteria and a score (Total/Partial) will be assigned depending on the defined logic.

The process 100 of the present disclosure may be implemented as a software program that runs on a computing device. In some embodiments, the software program is part of a software system, which may include a server application, one or more client applications, one or more middle tier applications that provides one or more services, and one or more databases for persisting data related to the creation of educational assessments. In some embodiments, the software program may include a graphical user interface (GUI) comprising one or more of the following reusable modular GUI components. This list of possible constituent GUI components is intended to be exemplary only and it is not intended that this list be used to limit the process of the present application, when implemented as a software program, to just these GUI components. Persons having ordinary skill in the art relevant to the present disclosure may understand there to be equivalent GUI components that may be substituted within the present disclosure without changing the essential function or operation of the process.

1. Navigator

2. Widget menu

3. Editing canvas

4. Canvas options

5. Widget options

6. Widget selection

7. Widget editing

8. Navigation

9. Canvas in runtime mode

10. Widget interaction

11. State update

12. Scoring rubric definition

13. Point assignment

By way of example, FIG. 4 conceptually illustrates an example graphical user interface (GUI) of a software application that creates educational assessments by using a set of reusable modular GUI components in some embodiments. As shown in this figure, the GUI includes a navigator 10, a canvas 12, and a widget list 14 comprising a currently selected widget 16 among a plurality of widgets in the list 14. Within the canvas 12 region, the GUI further includes a set of canvas level options 18, a set of widget level options 20, and an editing interface 22. While the various GUI components presented in FIG. 4 are illustrated in a particular manner, the layout of these GUI components is only exemplary and not intended to limit the scope or nature of the relationships between the various GUI components.

In FIG. 5, another example GUI of a software application that creates educational assessments by using a set of reusable modular GUI components is shown. In addition to the navigator 10 and the canvas 12, the GUI illustrated in this figure further includes a scoring rubric definition component 24, a state indicator 26, a state creator 28, an example goal box component 30, and a drag box 32. Thus, a user has a set of reusable modular GUI components from which to select for creating an educational assessment. As noted above by reference to FIG. 4, the various GUI components presented in FIG. 5 are illustrated in an exemplary layout which is not intended to limit the scope or nature of the relationships between these various GUI components. In some embodiments, the GUI components illustrated in FIGS. 4 and 5 can be included in single GUI display, with the widget list 14, the scoring rubric definition component 24, the state indicator 26, and the state creator 28 displayed adjacent to the GUI on either or both sides of the GUI.

To make the software program that implements the process of the present disclosure, a person would need to develop a GUI with the set of reusable modular GUI components and write a program that logically performs the steps of the process described above by reference to FIGS. 1-3. However, in some embodiments, defining the scoring logic in the scoring phase is optional, as long as other scoring operations are included to score the test questions created using this process. Furthermore, a large catalog of widgets with diverse capabilities for interactivity and customization options enhance operation of the software program, allowing greater creative depth to be explored in the development and creation of educational assessments.

Additionally: The process described in the invention can be used to create a content development and management platform for test question authoring and management. The process would also be able to create a platform for curriculum and learning content management, which includes the management of tools such as textbooks and learning aids.

Also, it can create: Test Item Banking and Management systems

Content Management systems

Learning Management Systems

Many of the above-described features and applications are implemented as software processes that are specified as a set of instructions recorded on a computer readable storage medium (also referred to as computer readable medium or machine readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

FIG. 6 conceptually illustrates an electronic system 600 with which some embodiments of the invention are implemented. The electronic system 600 may be a computer, phone, PDA, or any other sort of electronic device. Such an electronic system includes various types of computer readable media and interfaces for various other types of computer readable media. Electronic system 600 includes a bus 605, processing unit(s) 610, a system memory 615, a read-only 620, a permanent storage device 625, input devices 630, output devices 635, and a network 640.

The bus 605 collectively represents all system, peripheral, and chipset buses that communicatively connect the numerous internal devices of the electronic system 600. For instance, the bus 605 communicatively connects the processing unit(s) 610 with the read-only 620, the system memory 615, and the permanent storage device 625.

From these various memory units, the processing unit(s) 610 retrieves instructions to execute and data to process in order to execute the processes of the invention. The processing unit(s) may be a single processor or a multi-core processor in different embodiments.

The read-only-memory (ROM) 620 stores static data and instructions that are needed by the processing unit(s) 610 and other modules of the electronic system. The permanent storage device 625, on the other hand, is a read-and-write memory device. This device is a non-volatile memory unit that stores instructions and data even when the electronic system 600 is off. Some embodiments of the invention use a mass-storage device (such as a magnetic or optical disk and its corresponding disk drive) as the permanent storage device 625.

Other embodiments use a removable storage device (such as a floppy disk or a flash drive) as the permanent storage device 625. Like the permanent storage device 625, the system memory 615 is a read-and-write memory device. However, unlike storage device 625, the system memory 615 is a volatile read-and-write memory, such as a random access memory. The system memory 615 stores some of the instructions and data that the processor needs at runtime. In some embodiments, the invention's processes are stored in the system memory 615, the permanent storage device 625, and/or the read-only 620. For example, the various memory units include instructions for processing appearance alterations of displayable characters in accordance with some embodiments. From these various memory units, the processing unit(s) 610 retrieves instructions to execute and data to process in order to execute the processes of some embodiments.

The bus 605 also connects to the input and output devices 630 and 635. The input devices enable the user to communicate information and select commands to the electronic system. The input devices 630 include alphanumeric keyboards and pointing devices (also called “cursor control devices”). The output devices 635 display images generated by the electronic system 600. The output devices 635 include printers and display devices, such as cathode ray tubes (CRT) or liquid crystal displays (LCD). Some embodiments include devices such as a touchscreen that functions as both input and output devices.

Finally, as shown in FIG. 6, bus 605 also couples electronic system 600 to a network 640 through a network adapter (not shown). In this manner, the computer can be a part of a network of computers (such as a local area network (“LAN”), a wide area network (“WAN”), or an Intranet), or a network of networks (such as the Internet). Any or all components of electronic system 600 may be used in conjunction with the invention.

These functions described above can be implemented in digital electronic circuitry, in computer software, firmware or hardware. The techniques can be implemented using one or more computer program products. Programmable processors and computers can be packaged or included in mobile devices. The processes and logic flows may be performed by one or more programmable processors and by one or more set of programmable logic circuitry. General and special purpose computing and storage devices can be interconnected through communication networks.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the invention has been described with reference to numerous specific details, one of ordinary skill in the art will recognize that the invention can be embodied in other specific forms without departing from the spirit of the invention. For example, a process is conceptually illustrated in FIGS. 1-3. The specific operations of this process may not be performed in the exact order shown and described. Specific operations may not be performed in one continuous series of operations, and different specific operations may be performed in different embodiments. Furthermore, the processes could be implemented using several sub-processes, or as part of larger macro processes. Also, FIGS. 4 and 5 illustrate examples of a graphical user interface (GUI) of a software application that implements the process described by reference to FIGS. 1-3. The specific layout and design of the GUI may not be organized in exactly the same manner and may include different items and tools than those shown in the GUI of FIGS. 4 and 5. Thus, one of ordinary skill in the art would understand that the invention is not to be limited by the foregoing illustrative details and examples, but rather is to be defined by the appended claims.

I claim:

1. A non-transitory computer readable medium storing an authoring program which when executed by at least one processing unit of a computing device generates a graphical user interface (GUI) comprising a set of authoring tools for creating an assessment item, said program comprising sets of instructions for:
displaying a canvas on a display screen of the computing device, said canvas for working with one or more reusable modular GUI items in relation to creating the assessment item, wherein the canvas is configured to approximately replicate the display of a live test administration of the assessment item contemporaneously with creating the assessment item;
providing a set of editing GUI tools for editing modular GUI items used to create the assessment item;
providing a set of scoring GUI tools for designating scoring rubric components used to score a set of possible responses to the assessment item; and
providing a set of preview GUI tools for previewing the assessment item while the canvas is displayed for authoring the assessment item.

2. The non-transitory computer readable medium of claim 1, wherein the set of instructions for displaying the canvas comprises a set of instructions for opening an empty canvas to create the assessment item, wherein the empty canvas is displayed without any of the editing modular GUI items and scoring rubric components displayed as parts of the assessment item being created.

3. The non-transitory computer readable medium of claim 1, wherein the set of instructions for displaying the canvas comprises a set of instructions for opening a pre-populated canvas comprising one of an existing assessment item and an assessment item template, wherein the pre-populated canvas is displayed with at least one of an editing modular GUI item and a scoring rubric component.

4. The non-transitory computer readable medium of claim 1, wherein the set of editing GUI tools comprises a set of item modification tools to edit properties of editing modular GUI items and scoring rubric components that are part of the assessment item.

5. The non-transitory computer readable medium of claim 1, wherein the set of editing GUI tools comprises a set of inclusion tools for adding to the assessment item, wherein said program further comprises a set of instructions for updating the display of the canvas after adding to the assessment item.

6. The non-transitory computer readable medium of claim 1, wherein the set of editing GUI tools comprises a set of deletion tools for removing from the assessment item, wherein said program further comprises a set of instructions for updating the display of the canvas after removing from the assessment item.

7. The non-transitory computer readable medium of claim 1, wherein the set of scoring GUI tools comprises a scoring tool for setting a scoring mode for the assessment item, wherein said program further comprises a set of instructions for toggling, when the scoring tool is used to set the scoring mode for the assessment item, between an automatic scoring mode and a human scoring mode.

8. The non-transitory computer readable medium of claim 1, wherein the set of scoring GUI tools comprises a scoring tool for setting a maximum point score an assessment item is worth.

9. The non-transitory computer readable medium of claim 1, wherein the set of scoring GUI tools comprises a run-time scoring tool that, when selected, allows the author to create new scoring rubrics by performing interactions that would be available during a live test administration to reach a state of the assessment item that is associated with scoring credit.

10. The non-transitory computer readable medium of claim 9, wherein the run-time scoring tool is user-selectable so that the author can specify how much credit a particular state receives when that the particular state is part of a response submitted during a live test administration of the assessment item.

11. The non-transitory computer readable medium of claim 1, wherein the set of preview GUI tools comprises a preview tool that allows the author to perform interactions that would be permissible during a live test administration of the assessment item.

12. The non-transitory computer readable medium of claim 1, wherein said program further comprises a set of instructions for displaying one or more lists of selectable widgets, wherein said widgets represent modular components that can be added to the assessment item.

13. The non-transitory computer readable medium of claim 12, wherein each selectable widget in a list can be selected in the list and dragged to the canvas to add the widget to the assessment item.

14. A non-transitory computer readable medium storing a program which when executed by at least one processing unit of a computing device provides an educational assessment item authoring environment, said program comprising sets of instructions for:
displaying, on a display screen of the computing device, a graphical user interface (GUI) for interacting with a set of reusable modular widgets that are selectable to use in an educational assessment item, said GUI comprising (i) a widget canvas display area to work with reusable modular widgets associated with the educational assessment item, (ii) a widget list display area to select reusable modular widgets to place in the canvas display area to associate with the educational assessment item, and (iii) a navigator tool to set the authoring environment to one of a plurality of authoring phases comprising an editing phase, a scoring phase, and a previewing phase;
receiving a selection of the navigator tool to set the authoring environment to one of the plurality of authoring phases;
identifying the selected authoring phase;
when the selected authoring phase is the editing phase, setting any reusable modular widget that is in the widget canvas display area to be selectable and editable;
when the selected authoring phase is the scoring phase, displaying any scoring rubrics associated with the assessment item in the workspace and setting any displayed scoring rubrics to be modifiable; and
when the selected authoring phase is the previewing phase, displaying the educational assessment item approximately the same as the educational assessment item is displayed during a live test administration in which a user of the authoring environment can interact in real-time to preview the educational assessment item.

15. The non-transitory computer readable medium of claim 14, wherein the set of instructions for setting scoring rubrics for an assessment item comprises a set of instructions for configuring a scoring mode to one of automated scoring rubrics and non-automated scoring rubrics that require a human grader to inspect responses to the assessment item.

16. The non-transitory computer readable medium of claim 15, wherein the set of instructions for configuring the scoring mode comprises a set of instructions for specifying new scoring rubrics according to operations that (i) simulate interactions with the assessment item during live test administration and (ii) achieve a state desired by the author, wherein the achieved state is associated with a new scoring rubric of the assessment item, said new scoring rubric is assigned a particular amount of credit that is automatically applied to the grading of a test when the state associated with the new scoring rubric is achieved during the test.

17. The non-transitory computer readable medium of claim 14, wherein the set of instructions for setting the scoring rubrics comprises a set of instructions for associating automated scoring rubrics with possible response states of the assessment item and with an amount of credit to apply when the scoring rubric applies to a response.

18. The non-transitory computer readable medium of claim 17, wherein the set of instructions for setting the automated scoring rubrics comprises a set of instructions for adding new scoring rubrics to be associated with the assessment item.

19. The non-transitory computer readable medium of claim 14, wherein the set of instructions for setting any reusable modular widget that is in the widget canvas display area to be selectable and editable comprises sets of instructions for:
receiving placement of a reusable modular widget in the canvas display area; and
associating the reusable modular widget placed in the canvas display area with the educational assessment item.

20. The non-transitory computer readable medium of claim 14, wherein the set of instructions for setting any reusable modular widget that is in the widget canvas display area to be selectable and editable comprises sets of instructions for:
receiving movement of a reusable modular widget out from the canvas display area to a place outside of the widget canvas display area; and
disassociating, from the educational assessment item, the reusable modular widget moved out from the widget canvas display area.
